(19) United States
(12) Patent Application Publication
(10) Pub. No.: US 2025/0347285 A1
(43) Pub. Date: Nov. 13, 2025

(54) FAN MONITORING METHOD, SYSTEM, AND APPARATUS, SERVER, AND READABLE STORAGE MEDIUM

(71) Applicant: Suzhou MetaBrain Intelligent Technology Co., Ltd., Suzhou (CN)

(72) Inventors: Yuxi WANG, Suzhou (CN); Guangzhi LIU, Suzhou (CN); An WU, Suzhou (CN); Jiaming HUANG, Suzhou (CN)

(73) Assignee: Suzhou MetaBrain Intelligent Technology Co., Ltd., Suzhou, JS (CN)

(21) Appl. No.: 18/871,696

(22) PCT Filed: Aug. 9, 2023
(86) PCT No.: PCT/CN2023/111986

§ 371 Date: Dec. 4, 2024

(30) Foreign Application Priority Data
Aug. 9, 2022 (CN) 202210947593.7

(51) Int. Cl. F04D 27/00; G06F 11/30

(52) U.S. Cl. CPC F04D 27/001; G06F 11/3058

(57) ABSTRACT

A fan monitoring method, system, and apparatus, a server, and a readable storage medium, relating to the field of fan monitoring. The fan monitoring method is applied to a baseboard management controller (BMC), and includes: acquiring a noise signal of a fan collected by a microphone (S101); on the basis of the noise signal, obtaining signal feature data and the blade passing frequency (BPF) of the fan (S102); imputing the signal feature data into a pre-constructed status diagnostic model to obtain diagnostic data (S103); and on the basis of the diagnostic data and the BPF, generating status diagnostic prompt information for the fan (S104). The comprehensiveness of fault diagnosis for fans is improved, and fault diagnosis of fans can be completed just by means of noise signals collected by microphones, whereby the hardware architecture is simple, avoiding occupying excessive hardware resources.

### CROSS-REFERENCE TO RELATED APPLICATION

This application claims priority to Chinese Patent Application No. 202210947593.7, filed on Aug. 9, 2022, in China National Intellectual Property Administration and entitled “Fan Monitoring Method, System, and Apparatus, Server, and Readable Storage Medium”, which is hereby incorporated by reference in its entirety.

### FIELD

The present application relates to the field of fan monitoring, and in particular to a fan monitoring method, system, and apparatus, a server, and a readable storage medium.

### BACKGROUND

As critical heat dissipation components within servers, a faulty fan can cause abnormal noise, system errors, and even shutdown due to overheating protection in the server. Currently, the fan in the server can only feedback speed signals to the system via the Tach terminal for adjusting and monitoring the speed of the fan. However, these speed signals do not adequately reflect the health status of the fan. Therefore, to monitor the health status of the fan, it is necessary to provide additional voltage and current measurement circuits, clock circuits, analog-to-digital (AD) sampling and calibration circuits, humidity-sensitive capacitors, and the like, which makes the already crowded mainboard of the server more difficult to lay out and design, and the hardware occupies too many system resources.

Therefore, providing a solution to the above technical problems is a challenge that those skilled in the art currently need to address.

### SUMMARY

An object of the present application is to provide a fan monitoring method, system, and apparatus, a server, and a readable storage medium. The comprehensiveness of fault diagnosis for fans is improved, and fault diagnosis of fans can be completed just utilizing noise signals collected by microphones, whereby the hardware architecture is simple, without occupying excessive hardware resources.

To solve the above technical problems, the present application provides a fan monitoring method, which is applied to a baseboard management controller (BMC); the fan monitoring method includes:
acquiring a noise signal of a fan collected by a microphone;
obtaining signal feature data and a blade passing frequency (BPF) of the fan based on the noise signal;
inputting the signal feature data into a pre-constructed status diagnostic model to obtain diagnostic data; and
generating status diagnostic prompt information for the fan based on the diagnostic data and the BPF.

In some embodiments of the present application, the fan monitoring method further includes:
calculating a deviation percentage between the BPF and a reference BPF;
wherein the process of generating status diagnostic prompt information for the fan based on the diagnostic data and the BPF includes:
generating the status diagnostic prompt information for the fan based on the diagnostic data and the deviation percentage.

In some embodiments of the present application, the fan monitoring method further includes:
performing stepped frequency sweep on the fan according to a preset rule to obtain an initial BPF of the fan under each pulse width modulation (PWM) duty ratio; and
constructing, based on all PWM duty ratios corresponding to the stepped frequency sweep and the initial BPF under each PWM duty ratio, a mapping table of the PWM duty ratios and the BPFs;
wherein the process of calculating a deviation percentage between the BPF and a reference BPF includes:
determining a current PWM duty ratio corresponding to the BPF;
determining the reference BPF based on the current PWM duty ratio and the initial BPF in the mapping table; and
calculating the deviation percentage between the BPF and the reference BPF.

In some embodiments of the present application, the process of determining the reference BPF based on the current PWM duty ratio and the initial BPF in the mapping table includes:
determining whether the current PWM duty ratio corresponding to the BPF exists in the mapping table;
if so, using the initial BPF corresponding to the current PWM duty ratio in the mapping table as the reference BPF;
if not, determining a first target PWM duty ratio and a second target PWM duty ratio in the mapping table based on the current PWM duty ratio; and
calculating a reference BPF corresponding to the current PWM duty ratio according to an initial BPF corresponding to the first target PWM duty ratio and an initial BPF corresponding to the second target PWM duty ratio,
where the first target PWM duty ratio is adjacent to the second target PWM duty ratio, the first target PWM duty ratio is less than the current PWM duty ratio, and the second target PWM duty ratio is greater than the current PWM duty ratio.

In some embodiments of the present application, the process of calculating a reference BPF corresponding to the current PWM duty ratio according to an initial BPF corresponding to the first target PWM duty ratio and an initial BPF corresponding to the second target PWM duty ratio includes:
determining a first initial BPF corresponding to the first target PWM duty ratio and a second initial BPF corresponding to the second target PWM duty ratio; and
performing differential calculation on the first initial BPF and the second initial BPF to obtain the reference BPF corresponding to the current PWM duty ratio.

In some embodiments of the present application, the signal feature data includes time-domain feature data, frequency-domain feature data, and time-frequency-domain feature data.

In some embodiments of the present application, the process of obtaining a BPF of the fan based on the noise signal includes:
performing fast Fourier transform (FFT) processing on the noise signal to obtain spectral data; and
calculating the BPF based on the spectral data.

In some embodiments of the present application, the performing FFT processing on the noise signal to obtain spectral data includes:
performing FFT processing on the noise signal to convert the noise signal from a time domain to a frequency domain to obtain the spectral data.

In some embodiments of the present application, the diagnostic data includes health status, or, fault status and fault causes corresponding to the fault status.

In some embodiments of the present application, the fault causes include one or more of blade eccentricity, bearing wear, winding performance degradation, insufficient or drained lubricating oil, and resistance changes of integrated circuit (IC) elements.

In some embodiments of the present application, the fan monitoring method further includes:
adjusting a speed of the fan according to the BPF.

In some embodiments of the present application, the BPF is proportional to the speed of the fan.

In some embodiments of the present application, the process of pre-constructing the status diagnostic model includes:
acquiring noise samples of the fan in a target electronic device, where the noise samples include fault noise samples and non-fault noise samples, and adding respective labels to the fault noise samples and the non-fault noise samples;
extracting feature data in each of the noise samples, combining the feature data into matrix samples, and dividing the matrix samples into first matrix samples and second matrix samples;
inputting the first matrix samples into a classifier for training to obtain a plurality of models; and
loading the second matrix samples into the plurality of models for testing, and selecting an optimal model as the status diagnostic model according to test results.

In some embodiments of the present application, the adding respective labels to the fault noise samples and the non-fault noise samples includes:
setting the labels of the non-fault noise samples as non-fault; and
setting the labels of the fault noise samples as the fault causes.

In some embodiments of the present application, the method further includes:
verifying sensitivity of the microphone after server products are assembled and before leaving the factory; and
executing, after the sensitivity verification of the microphone is passed, the acquiring a noise signal of a fan collected by a microphone.

In some embodiments of the present application, the microphone is disposed on a side of a mainboard of the server near the fan.

To solve the above technical problems, the present application further provides a fan monitoring system, which is applied to a BMC; the fan monitoring system includes:
an acquisition module, configured to acquire a noise signal of a fan collected by a microphone;
an extraction module, configured to obtain signal feature data and a blade passing frequency (BPF) of the fan based on the noise signal;
a diagnostic module, configured to input the signal feature data into a pre-constructed status diagnostic model to obtain diagnostic data; and
an information generation module, configured to generate status diagnostic prompt information for the fan based on the diagnostic data and the BPF.

To solve the above technical problems, the present application further provides a fan monitoring apparatus, including:
a memory, configured to store computer programs; and
a processor, configured to implement steps of the above fan monitoring method when executing the computer programs.

To solve the above technical problems, the present application further provides a server including the above fan monitoring apparatus.

To solve the above technical problem, the present application further provides a non-volatile readable storage medium, where the non-volatile readable storage medium stores computer programs thereon, and the computer programs, when executed by a processor, implement the steps of any one of the above fan monitoring methods.

The present application provides a fan monitoring method, which is applied to a BMC, utilizes a microphone to acquire a noise signal of a fan, extracts signal feature data and a BPF of the fan based on the noise signal, inputs the signal feature data into a preset diagnostic model to obtain the diagnostic data of the fan, determines the status diagnostic result of the fan according to the diagnostic data and the BPF together, which makes the diagnosis more comprehensive, can complete the fault diagnosis only by the noise signal collected by the microphone, whereby the hardware architecture is simple, avoiding occupying excessive hardware resources. The present application further provides a fan monitoring system and apparatus, a server, and a readable storage medium, which have the same beneficial effects as the above fan monitoring method.

### BRIEF DESCRIPTION OF THE DRAWINGS

To explain the technical solutions of the embodiments of the present application more clearly, a brief introduction will be made to the drawings used in the embodiments. It is obvious that the drawings in the description below are only some embodiments of the present application, and the ordinarily skilled in the art may obtain other drawings according to these drawings without creative work.

FIG. 1 is a flowchart of steps of a fan monitoring method provided by the present application;

FIG. 2 is a structural diagram of a BMC provided by the present application;

FIG. 3 is a flowchart for acquiring a reference BPF corresponding to a current PWM duty ratio provided by the present application;

FIG. 4 is a structural diagram of a fan monitoring system provided by the present application; and

FIG. 5 is a structural diagram of a non-volatile readable storage medium provided by the present application.

### DETAILED DESCRIPTION

The core of the present application is to provide a fan monitoring method, system, and apparatus, a server, and a readable storage medium. The comprehensiveness of fault diagnosis for fans is improved, and fault diagnosis of fans can be completed just by means of noise signals collected by microphones, whereby the hardware architecture is simple, avoiding occupying excessive hardware resources.

To make the object, technical solution, and advantages of the embodiments of the present application clearer, the technical solution in the embodiment of the present application is described clearly and completely in combination with the drawings in the embodiments of the present application. The described embodiments are a part of the embodiments of the present application, but not the whole embodiments. Based on the embodiments in the present application, all the other embodiments obtained by the ordinarily skilled in the art without involving any inventive effort fall within the scope of protection of the present application.

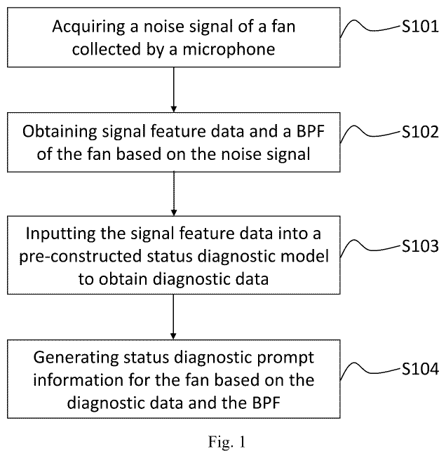

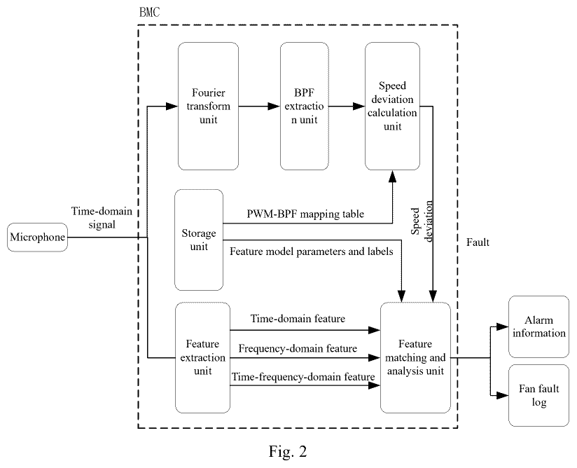

Referring to FIG. 1, FIG. 1 is a flowchart of steps of a fan monitoring method provided by the present application, and the fan monitoring method can be applied to an electronic product that uses a fan as a heat dissipation apparatus, such as a personal computer (PC) and an edge server. To facilitate understanding of the solution of the present application, the application to a server will be described as an example. The above fan monitoring method may be realized by a BMC. The BMC, as shown in FIG. 2, includes a Fourier transform unit, a storage unit, a feature extraction unit, a BPF extraction unit, a speed deviation calculation unit, and a feature matching and analysis unit. The fan monitoring method includes:

S101: Acquire a noise signal of a fan collected by a microphone.

Specifically, one or more microphones configured for collecting noise signals of fans are integrated into the mainboard of the server. In some embodiments of the present application, the microphone may be provided on a side of a mainboard of the server near the fan to facilitate collection of the noise signal.

Specifically, the microphone collects the noise signal of the fan according to a preset period, the preset period may be set to 1 h, and the sampling time may be set to 10 s.

The preset period and the sampling time may be set according to actual needs, and the present application does not specifically limit them here.

S102: Obtain signal feature data and a BPF of the fan based on the noise signal.

Specifically, after acquiring the noise signal, the BMC inputs the noise signal to the Fourier transform unit and the feature extraction unit, and performs signal feature extraction on the noise signal by the feature extraction unit to obtain signal feature data, the signal feature data including but not limited to time-domain feature data, frequency-domain feature data, and time-frequency-domain feature data, and specifically including but not limited to kurtosis index, power spectral density (PSD) discrete peak value and frequency, and waterfall diagram of PSD and time.

It can be understood that the noise signal collected by the microphone is a time-domain signal, and the noise signal is sent to the Fourier transform unit to perform FFT processing on the noise signal; the noise signal is converted from the time domain to the frequency domain to obtain spectral data, and the BPF is calculated based on the spectral data, where the spectral data with a frequency resolution of dƒ is an array of N rows and 2 columns [df, p₁; 2df, p₂; 3df, p₃; . . . ; Ndf, p_{N}].

S103: Input the signal feature data into a pre-constructed status diagnostic model to obtain diagnostic data.

Before executing the step, the method may further include pre-training the preset diagnostic model. In some embodiments of the present application, the process of pre-constructing the status diagnostic model includes:

acquiring noise samples of the fan in a target electronic device, where the noise samples include fault noise samples and non-fault noise samples, and adding respective labels to the fault noise samples and the non-fault noise samples;
extracting feature data in each of the noise samples, combining the feature data into matrix samples, and dividing the matrix samples into first matrix samples and second matrix samples;
inputting the first matrix samples into a classifier for training to obtain a plurality of models; and
loading the second matrix samples into the plurality of models for testing, and selecting an optimal model as the status diagnostic model according to test results.

Specifically, sufficient fault noise samples and non-fault noise samples are collected, the label of the non-fault sample is non-fault, and the label of the fault sample indicates a specific fault cause, such as blade eccentricity, bearing wear, winding performance degradation, insufficient or drained lubricating oil, and resistance changes of IC elements. After the fault label is marked, signal feature extraction is performed, including time-domain features, frequency-domain features, and time-frequency-domain features. The kurtosis index, PSD discrete peak value and frequency, and waterfall diagram of PSD and time applied in the embodiment, and these feature data are combined into a matrix. Most of the matrix samples are input into the classifier algorithm for training, and a series of models will be output after the model training is completed. The remaining matrix samples are loaded into the model generated in the previous step for testing. According to the test results, the best-performing model is selected, and the model code is saved in the dedicated storage unit of BMC.

In the practical application process, the signal feature data obtained based on the noise signal is input into the trained preset diagnostic model, and the preset diagnostic model can output the diagnostic data of the fan, and the diagnostic data includes health status, or, fault status and fault causes corresponding to the fault status, where the fault causes include but not limited to one or more of blade eccentricity, bearing wear, winding performance degradation, insufficient or drained lubricating oil, and resistance changes of IC elements, whereby the operator can be aware of the status of the fan in time and make timely response.

S104: Generate status diagnostic prompt information for the fan based on the diagnostic data and the BPF.

It can be understood that whether there is a communication fault in the fan, such as a communication line fault, or the like, may be determined according to the BPF. Therefore, the present application jointly obtains status diagnostic prompt information for the fan based on the diagnostic data and the BPF, thereby making the diagnostic result more comprehensive. Whereby the status diagnostic prompt information includes alarm information, fan fault log, or the like.

It can be seen that the fan monitoring method provided by the present embodiment utilizes a microphone to acquire a noise signal of a fan, extracts signal feature data and a BPF of the fan based on the noise signal, inputs the signal feature data into a preset diagnostic model to obtain the diagnostic data of the fan, determines the status diagnostic result of the fan according to the diagnostic data and the BPF together, which makes the diagnosis more comprehensive, can complete the fault diagnosis only by the noise signal collected by the microphone, whereby the hardware architecture is simple, without occupying excessive hardware resources.

Based on the above embodiments:

In some embodiments of the present application, the fan monitoring method further includes:
calculating a deviation percentage between the BPF and a reference BPF;
wherein the process of generating status diagnostic prompt information for the fan based on the diagnostic data and the BPF includes:
generating the status diagnostic prompt information for the fan based on the diagnostic data and the deviation percentage.

The deviation of the BPF is a deviation percentage between the current BPF extracted from the current noise signal and the reference BPF under the same PWM duty ratio. It can be understood that when the deviation percentage is relatively small, the fan is normally controlled, and when the deviation percentage is greater than the preset threshold, the fan is out of control due to some reasons, and there is an abnormality in the fan at this time. Therefore, the deviation percentage can also be used as the basis for a fan fault. Corresponding prompt information may be generated according to the deviation percentage and the diagnostic data, and it can be understood that the prompt information includes the fault status and the corresponding alarm information when the deviation percentage is too large.

In some embodiments of the present application, the fan monitoring method further includes:
performing stepped frequency sweep on the fan according to a preset rule to obtain an initial BPF of the fan under each PWM duty ratio; and
constructing, based on all PWM duty ratios corresponding to the stepped frequency sweep and the initial BPF under each PWM duty ratio, a mapping table of the PWM duty ratios and the BPFs;
wherein the process of calculating a deviation percentage between the BPF and a reference BPF including:
determining a current PWM duty ratio corresponding to the BPF;
determining the reference BPF based on the current PWM duty ratio and the initial BPF in the mapping table; and
calculating the deviation percentage between the BPF and the reference BPF.

In some embodiments of the present application, the method includes the following steps: verifying sensitivity of the microphone after server products are assembled and before leaving the factory; and executing, after the sensitivity verification of the microphone is passed, the acquiring a noise signal of a fan collected by a microphone.

Specifically, after the server products are assembled and before leaving the factory, it is necessary to verify the sensitivity of the microphone at a suitable temperature and humidity. Here, suitable refers to being as close to the actual working environment as possible. In addition, it is necessary to start the stepped frequency sweep of the fan, collect the time-domain signals collected by the microphone under different PWM duty ratios, extract the BPF in its initial status, and save the mapping table of PWM-BPF to the dedicated storage unit of BMC.

Specifically, the stepped frequency sweep of the fan from 10% to 100% PWM duty is started, time-domain signals corresponding to different PWM duty ratios are collected, the BPF in the initial status is extracted, and the PWM-BPF mapping table is saved in the dedicated storage unit of the BMC. The mapping table is an array of 10 rows and 2 columns, Matrix_{BPF}=[10%, F₁; 20%, F₂; . . . , 100%, F₁₀].

In some embodiments of the present application, the process of determining the reference BPF based on the current PWM duty ratio and the initial BPF in the mapping table includes:
determining whether the current PWM duty ratio corresponding to the BPF exists in the mapping table;
if so, using the initial BPF corresponding to the current PWM duty ratio in the mapping table as the reference BPF;
if not, determining a first target PWM duty ratio and a second target PWM duty ratio in the mapping table based on the current PWM duty ratio; and
calculating a reference BPF corresponding to the current PWM duty ratio according to an initial BPF corresponding to the first target PWM duty ratio and an initial BPF corresponding to the second target PWM duty ratio,
where the first target PWM duty ratio is adjacent to the second target PWM duty ratio, the first target PWM duty ratio is less than the current PWM duty ratio, and the second target PWM duty ratio is greater than the current PWM duty ratio.

In some embodiments of the present application, the process of calculating a reference BPF corresponding to the current PWM duty ratio according to an initial BPF corresponding to the first target PWM duty ratio and an initial BPF corresponding to the second target PWM duty ratio includes:
determining a first initial BPF corresponding to the first target PWM duty ratio and a second initial BPF corresponding to the second target PWM duty ratio; and
performing differential calculation on the first initial BPF and the second initial BPF to obtain the reference BPF corresponding to the current PWM duty ratio.

Specifically, considering the PWM-BPF mapping table is constructed through the stepped frequency sweep, the PWM duty ratio may not be in the PWM-BPF mapping table in actual operation. Therefore, after determining the current PWM duty ratio, it is first determined whether the current PWM duty ratio exists in the mapping table, and if so, the initial BPF directly matching the same PWM duty ratio is used as the reference BPF corresponding to the current PWM duty ratio. If the current PWM duty ratio obtained in actual work is not in the mapping table, the reference BPF corresponding to the current PWM duty ratio is obtained by differential calculation using the initial BPFs of two PWM duty ratios closest to the current PWM duty ratio in the mapping table; assuming that the current PWM duty ratio is 34%, the reference BPF corresponding to 34% is obtained by differential calculation using the initial BPF corresponding to 30% and the initial BPF corresponding to 40% in the mapping table.

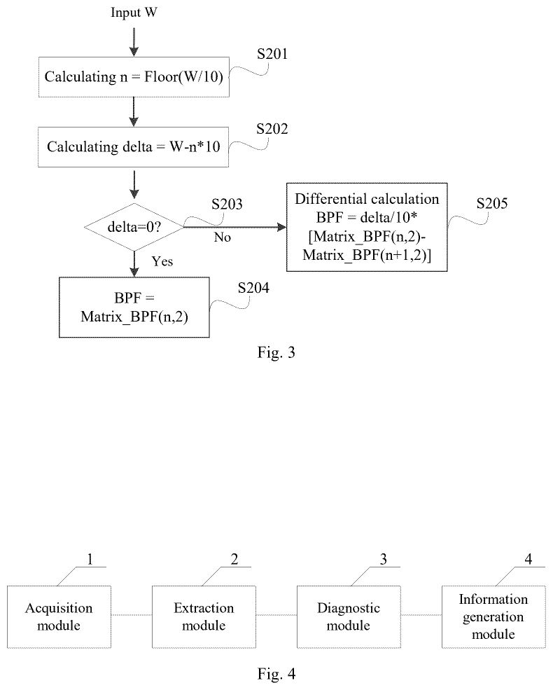

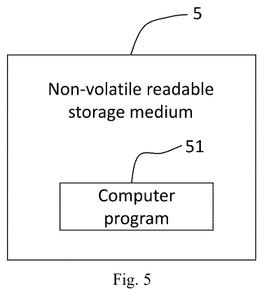

Specifically, first, the current PWM duty ratio value is retrieved from the BMC, and the corresponding BPF value is retrieved from the mapping table in the storage unit. If the current PWM duty ratio is not in the pre-stored parameter table, the BPF may be obtained by differential calculation. For example, if the current PWM duty ratio (replaced by W) is 34, the closest PWM in the mapping table is calculated by an integer ceiling function, that is, the first target PWM duty ratio and the second target PWM duty ratio, and the BPF corresponding to the current PWM duty ratio is calculated by performing the differential calculation between the first initial BPF corresponding to the first target PWM duty ratio and the second initial BPF corresponding to the second target PWM duty ratio. Referring to FIG. 3, FIG. 3 is a flowchart for acquiring a reference BPF corresponding to a current PWM duty ratio provided by the present application. Assuming W=34, n is calculated by S201 as 3, and delta is calculated by S202 as 4. It can be understood that if delta=0 in S203, the current PWM duty ratio is located in the mapping table and can be directly matched, that is, BPF corresponding to the current PWM duty ratio=Matrix_BPF (n, 2), and if delta≠0 in S203, the current PWM duty ratio is not in the mapping table, the reference BPF corresponding to the current PWM duty ratio is calculated by the differential calculation solution in S205.

In some embodiments of the present application, the fan monitoring method further includes:
adjusting a speed of the fan according to the BPF.

It can be understood that the BPF is proportional to the speed, and the deviation of the BPF is the deviation of the speed. Therefore, the speed of the fan can be monitored and adjusted according to the BPF in the step. With this solution, there is no need to set a speed control circuit or FG signal terminal in the fan, and the hardware architecture is simple.

In summary, the solution of the present application is adopted to integrate one or more microphones on the mainboard of the server, collect the noise of the fan, determine the health status of the fan through the feature analysis of the noise, pre-store model parameters and fault labels in the BMC, analyze the status of the fan online, issue an alarm after identifying the fault or fault trend, and calculate the speed through the signals collected by the microphones, and replace the reading element on the fan printed circuit board (PCB); the hardware architecture is simple and does not need to occupy too many resources in the system, and at the same time, it can locate the specific fault cause, and provide accurate suggestions for the maintenance of the server.

On the other hand, referring to FIG. 4. FIG. 4 is a structural diagram of a fan monitoring system provided by the present application, which is applied to a BMC. The fan monitoring system includes:
an acquisition module 1, configured to acquire a noise signal of a fan collected by a microphone;
an extraction module 2, configured to obtain signal feature data and a BPF of the fan based on the noise signal;
a diagnostic module 3, configured to input the signal feature data into a pre-constructed status diagnostic model to obtain diagnostic data; and
an information generation module 4, configured to generate status diagnostic prompt information for the fan based on the diagnostic data and the BPF.

It can be seen that the fan monitoring system provided by the present embodiment utilizes a microphone to acquire a noise signal of a fan, extracts signal feature data and a BPF of the fan based on the noise signal, inputs the signal feature data into a preset diagnostic model to obtain the diagnostic data of the fan, determines the status diagnostic result of the fan according to the diagnostic data and the BPF together, which makes the diagnosis more comprehensive, can complete the fault diagnosis only by the noise signal collected by the microphone, whereby the hardware architecture is simple, avoiding occupying excessive hardware resources.

In some embodiments of the present application, the fan monitoring system further includes:
a calculation module, configured to calculate the deviation percentage between the BPF and the reference BPF.

The process of generating status diagnostic prompt information for the fan based on the diagnostic data and the BPF includes:
generating the status diagnostic prompt information for the fan based on the diagnostic data and the deviation percentage.

In some embodiments of the present application, the fan monitoring system further includes:
a pre-processing module, configured to perform stepped frequency sweep on the fan according to a preset rule to obtain an initial BPF of the fan under each PWM duty ratio, and construct, based on all PWM duty ratios corresponding to the stepped frequency sweep and the initial BPF under each PWM duty ratio, a mapping table of the PWM duty ratios and the BPFs.

The process of calculating a deviation percentage between the BPF and a reference BPF includes:
determining a current PWM duty ratio corresponding to the BPF;
determining the reference BPF based on the current PWM duty ratio and the initial BPF in the mapping table; and
calculating the deviation percentage between the BPF and the reference BPF.

In some embodiments of the present application, the process of determining the reference BPF based on the current PWM duty ratio and the initial BPF in the mapping table includes:
determining whether the current PWM duty ratio corresponding to the BPF exists in the mapping table;
if so, using the initial BPF corresponding to the current PWM duty ratio in the mapping table as the reference BPF;
if not, determining a first target PWM duty ratio and a second target PWM duty ratio in the mapping table based on the current PWM duty ratio; and
calculating a reference BPF corresponding to the current PWM duty ratio according to an initial BPF corresponding to the first target PWM duty ratio and an initial BPF corresponding to the second target PWM duty ratio,
where the first target PWM duty ratio is adjacent to the second target PWM duty ratio, the first target PWM duty ratio is less than the current PWM duty ratio, and the second target PWM duty ratio is greater than the current PWM duty ratio.

In some embodiments of the present application, the process of calculating a reference BPF corresponding to the current PWM duty ratio according to an initial BPF corresponding to the first target PWM duty ratio and an initial BPF corresponding to the second target PWM duty ratio includes:
determining a first initial BPF corresponding to the first target PWM duty ratio and a second initial BPF corresponding to the second target PWM duty ratio; and
performing differential calculation on the first initial BPF and the second initial BPF to obtain the reference BPF corresponding to the current PWM duty ratio.

In some embodiments of the present application, the signal feature data includes time-domain feature data, frequency-domain feature data, and time-frequency-domain feature data.

In some embodiments of the present application, the process of obtaining a BPF of the fan based on the noise signal includes:
performing fast Fourier transform (FFT) processing on the noise signal to obtain spectral data; and
calculating the BPF based on the spectral data.

In some embodiments of the present application, the diagnostic data includes health status, or, fault status and fault causes corresponding to the fault status.

In some embodiments of the present application, the fault causes include one or more of blade eccentricity, bearing wear, winding performance degradation, insufficient or drained lubricating oil, and resistance changes of integrated circuit (IC) elements.

In some embodiments of the present application, the fan monitoring system further includes:
a control module, configured to adjust a speed of the fan according to the BPF.

In some embodiments of the present application, the process of pre-constructing the status diagnostic model includes:
acquiring noise samples of the fan in a target electronic device, where the noise samples include fault noise samples and non-fault noise samples, and adding respective labels to the fault noise samples and the non-fault noise samples;
extracting feature data in each of the noise samples, combining the feature data into matrix samples, and dividing the matrix samples into first matrix samples and second matrix samples;
inputting the first matrix samples into a classifier for training to obtain a plurality of models; and
loading the second matrix samples into the plurality of models for testing, and selecting an optimal model as the status diagnostic model according to test results.

In another aspect, the present application further provides a fan monitoring apparatus, including:
a memory, configured to store computer programs; and
a processor, configured to implement steps of the above fan monitoring method of any one of the embodiments when executing the computer programs.

Specifically, the memory includes a non-volatile storage medium and an internal memory. The non-volatile storage medium stores an operating system and computer-readable instructions, and the internal memory provides an environment for the operation of the operating system and computer-readable instructions in the non-volatile storage medium. The processor provides calculation and control capabilities for the fan monitoring apparatus, and when executing the computer programs saved in the memory, the following steps may be implemented: acquiring a noise signal of a fan collected by a microphone; obtaining signal feature data and a BPF of the fan based on the noise signal; inputting the signal feature data into a pre-constructed status diagnostic model to obtain diagnostic data; and generating status diagnostic prompt information for the fan based on the diagnostic data and the BPF.

It can be seen that the fan monitoring apparatus provided by the present embodiment utilizes a microphone to acquire a noise signal of a fan, extracts signal feature data and a BPF of the fan based on the noise signal, inputs the signal feature data into a preset diagnostic model to obtain the diagnostic data of the fan, determines the status diagnostic result of the fan according to the diagnostic data and the BPF together, which makes the diagnosis more comprehensive, can complete the fault diagnosis only by the noise signal collected by the microphone, whereby the hardware architecture is simple, avoiding occupying excessive hardware resources.

When the processor executes the computer subprogram saved in the memory, the processor may implement the following steps: calculating the deviation percentage between the BPF and the reference BPF; and generating the status diagnostic prompt information for the fan based on the diagnostic data and the deviation percentage.

In some embodiments of the present application, when the processor executes the computer subprograms saved in the memory, the processor may implement the following steps: performing stepped frequency sweep on the fan according to a preset rule to obtain an initial BPF of the fan under each PWM duty ratio; constructing, based on all PWM duty ratios corresponding to the stepped frequency sweep and the initial BPF under each PWM duty ratio, a mapping table of the PWM duty ratios and the BPFs; determining a current PWM duty ratio corresponding to the BPF; determining the reference BPF based on the current PWM duty ratio and the initial BPF in the mapping table; and calculating the deviation percentage between the BPF and the reference BPF.

In some embodiments of the present application, when the processor executes the computer subprogram saved in the memory, the processor may implement the following steps: determining whether the current PWM duty ratio corresponding to the BPF exists in the mapping table; if so, using the initial BPF corresponding to the current PWM duty ratio in the mapping table as the reference BPF; if not, determining a first target PWM duty ratio and a second target PWM duty ratio in the mapping table based on the current PWM duty ratio; and calculating a reference BPF corresponding to the current PWM duty ratio according to an initial BPF corresponding to the first target PWM duty ratio and an initial BPF corresponding to the second target PWM duty ratio, where the first target PWM duty ratio is adjacent to the second target PWM duty ratio, the first target PWM duty ratio is less than the current PWM duty ratio, and the second target PWM duty ratio is greater than the current PWM duty ratio.

In some embodiments of the present application, when the processor executes the computer subprogram saved in the memory, the processor may implement the following steps:
determining a first initial BPF corresponding to the first target PWM duty ratio and a second initial BPF corresponding to the second target PWM duty ratio; and performing differential calculation on the first initial BPF and the second initial BPF to obtain the reference BPF corresponding to the current PWM duty ratio.

In some embodiments of the present application, when the processor executes the computer subprogram saved in the memory, the processor may implement the following steps: obtaining signal feature data based on the noise signal, the signal feature data includes time-domain feature data, frequency-domain feature data, and time-frequency-domain feature data.

In some embodiments of the present application, when the processor executes the computer subprogram saved in the memory, the processor may implement the following steps: performing FFT processing on the noise signal to obtain spectral data; and calculating the BPF based on the spectral data.

In some embodiments of the present application, when the processor executes the computer subprogram saved in the memory, the processor may implement the following steps: inputting the signal feature data into a pre-constructed status diagnostic model to obtain diagnostic data, where the diagnostic data includes health status, or, fault status and fault causes corresponding to the fault status.

In some embodiments of the present application, when the processor executes the computer subprogram saved in the memory, the processor may implement the following steps: inputting the signal feature data into a pre-constructed status diagnostic model to obtain diagnostic data, where the diagnostic data includes health status, or, fault status and fault causes corresponding to the fault status; the fault causes include one or more of blade eccentricity, bearing wear, winding performance degradation, insufficient or drained lubricating oil, and resistance changes of IC elements.

In some embodiments of the present application, when the processor executes the computer subprogram saved in the memory, the processor may implement the following step: adjusting a speed of the fan according to the BPF.

In some embodiments of the present application, when the processor executes the computer subprogram saved in the memory, the processor may implement the following steps: acquiring noise samples of the fan in a target electronic device, where the noise samples include fault noise samples and non-fault noise samples, and adding respective labels to the fault noise samples and the non-fault noise samples; extracting feature data in each of the noise samples, combining the feature data into matrix samples, and dividing the matrix samples into first matrix samples and second matrix samples; inputting the first matrix samples into a classifier for training to obtain a plurality of models; and loading the second matrix samples into the plurality of models for testing, and selecting an optimal model as the status diagnostic model according to test results.

Based on the above embodiments, in some implementations of the present application, the fan monitoring apparatus further includes:
an input interface, connected with the processor and configured to acquire externally-imported computer programs, parameters, and instructions before storing the same in the memory under the control of the processor, where the input interface may be connected to the input apparatus to receive parameters or instructions manually input by the user; the input apparatus may be a touch layer covered on a display screen, and may also be a key, a trackball, or a touch pad arranged on a terminal housing;
a display unit, connected with the processor and configured to display data sent by the processor, where the display unit may be a liquid crystal display screen, an electronic ink display screen, or the like; and
a network port, connected with the processor and configured for communication connection with external terminal devices, where the communication technology used in the communication connection may be a wired communication technology or a wireless communication technology, such as mobile high-definition link (MHL), universal serial bus (USB), high definition multimedia interface (HDMI), wireless-fidelity (WiFi), Bluetooth communication, Bluetooth low energy (BLE) communication, communication technology based on IEEE802.11s, or the like.

In another aspect, the present application further provides a server including the fan monitoring apparatus as described in the above embodiments.

For the description of the server provided by the present application, please refer to the above embodiments, and the present application will not be repeatedly described herein.

The server provided by the present application has the same beneficial effects as the above fan monitoring apparatus.

In another aspect, the present application further provides a non-volatile readable storage medium, where the non-volatile readable storage medium stores computer programs 51 thereon, and the computer programs 51, when executed by a processor, implement steps of the above fan monitoring method of any one of the embodiments.

The non-volatile readable storage medium may include various media that can store the program code, such as U-disk, removable hard disk, read-only memory (ROM), random-access memory (RAM), and magnetic or optical disks. The storage medium stores computer programs thereon. When the computer programs are executed by the processor, the computer programs implement the following steps: acquiring a noise signal of a fan collected by a microphone; obtaining signal feature data and a BPF of the fan based on the noise signal; inputting the signal feature data into a pre-constructed status diagnostic model to obtain diagnostic data; and generating status diagnostic prompt information for the fan based on the diagnostic data and the BPF.

It can be seen that the present embodiment utilizes a microphone to acquire a noise signal of a fan, extracts signal feature data and a BPF of the fan based on the noise signal, inputs the signal feature data into a preset diagnostic model to obtain the diagnostic data of the fan, determines the status diagnostic result of the fan according to the diagnostic data and the BPF together, which makes the diagnosis more comprehensive, can complete the fault diagnosis only by the noise signal collected by the microphone, whereby the hardware architecture is simple, avoiding occupying excessive hardware resources.

In some embodiments of the present application, when the computer subprogram stored in the non-volatile readable storage medium is executed by the processor, the following steps may be specifically implemented: calculating the deviation percentage between the BPF and the reference BPF; and generating the status diagnostic prompt information for the fan based on the diagnostic data and the deviation percentage.

In some embodiments of the present application, when the computer subprogram stored in the non-volatile readable storage medium is executed by the processor, the following steps may be specifically implemented: performing stepped frequency sweep on the fan according to a preset rule to obtain an initial BPF of the fan under each PWM duty ratio; constructing, based on all PWM duty ratios corresponding to the stepped frequency sweep and the initial BPF under each PWM duty ratio, a mapping table of the PWM duty ratios and the BPFs; determining a current PWM duty ratio corresponding to the BPF; determining the reference BPF based on the current PWM duty ratio and the initial BPF in the mapping table; and calculating the deviation percentage between the BPF and the reference BPF.

In some embodiments of the present application, when the computer subprogram stored in the non-volatile readable storage medium is executed by the processor, the following steps may be specifically implemented: determining whether the current PWM duty ratio corresponding to the BPF exists in the mapping table; if so, using the initial BPF corresponding to the current PWM duty ratio in the mapping table as the reference BPF; if not, determining a first target PWM duty ratio and a second target PWM duty ratio in the mapping table based on the current PWM duty ratio; and calculating a reference BPF corresponding to the current PWM duty ratio according to an initial BPF corresponding to the first target PWM duty ratio and an initial BPF corresponding to the second target PWM duty ratio, where the first target PWM duty ratio is adjacent to the second target PWM duty ratio, the first target PWM duty ratio is less than the current PWM duty ratio, and the second target PWM duty ratio is greater than the current PWM duty ratio.

In some embodiments of the present application, when the computer subprogram stored in the non-volatile readable storage medium is executed by the processor, the following steps may be specifically implemented: determining a first initial BPF corresponding to the first target PWM duty ratio and a second initial BPF corresponding to the second target PWM duty ratio; and performing differential calculation on the first initial BPF and the second initial BPF to obtain the reference BPF corresponding to the current PWM duty ratio.

In some embodiments of the present application, when the computer subprogram stored in the non-volatile readable storage medium is executed by the processor, the following steps may be specifically implemented: obtaining signal feature data based on the noise signal, the signal feature data includes time-domain feature data, frequency-domain feature data, and time-frequency-domain feature data.

In some embodiments of the present application, when the computer subprogram stored in the non-volatile readable storage medium is executed by the processor, the following steps may be specifically implemented: performing FFT processing on the noise signal to obtain spectral data; calculating the BPF based on the spectral data.

In some embodiments of the present application, when the computer subprogram stored in the non-volatile readable storage medium is executed by the processor, the following steps may be specifically implemented: inputting the signal feature data into a pre-constructed status diagnostic model to obtain diagnostic data, where the diagnostic data includes health status, or, fault status and fault causes corresponding to the fault status.

In some embodiments of the present application, when the computer subprogram stored in the non-volatile readable storage medium is executed by the processor, the following steps may be specifically implemented: inputting the signal feature data into a pre-constructed status diagnostic model to obtain diagnostic data, where the diagnostic data includes health status, or, fault status and fault causes corresponding to the fault status; the fault causes include one or more of blade eccentricity, bearing wear, winding performance degradation, insufficient or drained lubricating oil, and resistance changes of IC elements.

In some embodiments of the present application, when the computer subprogram stored in the non-volatile readable storage medium is executed by the processor, the following steps may be specifically implemented: adjusting a speed of the fan according to the BPF.

In some embodiments of the present application, when the computer subprogram stored in the non-volatile readable storage medium is executed by the processor, the following steps may be specifically implemented: acquiring noise samples of the fan in a target electronic device, where the noise samples include fault noise samples and non-fault noise samples, and adding respective labels to the fault noise samples and the non-fault noise samples; extracting feature data in each of the noise samples, combining the feature data into matrix samples, and dividing the matrix samples into first matrix samples and second matrix samples; inputting the first matrix samples into a classifier for training to obtain a plurality of models; and loading the second matrix samples into the plurality of models for testing, and selecting an optimal model as the status diagnostic model according to test results.

It should also be noted that the use of relational terms such as first and second, and the like in the specification are used solely to distinguish one entity or operation from another entity or operation without necessarily requiring or implying any actual such relationship or order between such entities or operations. Moreover, the terms “include”, “contain”, or any other variation thereof, are intended to cover a non-exclusive inclusion, such that a process, method, article, or device that includes a list of elements does not include only those elements but may include other elements not expressly listed or inherent to such process, method, article, or device. An element proceeded by “include a . . . ” does not, without more constraints, preclude the existence of additional identical elements in the process, method, article, or device that includes the element.

The previous description of the disclosed embodiments is provided to enable the skilled in the art to implement or use the present application. Various modifications to these embodiments will be readily apparent to the skilled in the art, and the generic principles defined herein may be implemented in other embodiments without departing from the spirit or scope of the present application. Therefore, the present application will not be limited to these embodiments shown herein but will conform to the broadest scope consistent with the principles and novel features disclosed herein.

1. A fan monitoring method, comprising:
acquiring, by a microphone, a noise signal of a fan;
obtaining signal feature data and a blade passing frequency (BPF) of the fan based on the noise signal;
inputting the signal feature data into a pre-constructed status diagnostic model to obtain diagnostic data; and
generating status diagnostic prompt information for the fan based on the diagnostic data and the BPF.

2. The fan monitoring method according to claim 1, further comprising:
calculating a deviation percentage between the BPF and a reference BPF;
wherein generating the status diagnostic prompt information for the fan based on the diagnostic data and the BPF comprises:
generating the status diagnostic prompt information for the fan based on the diagnostic data and the deviation percentage.

3. The fan monitoring method according to claim 2, further comprising:
performing stepped frequency sweep on the fan according to a preset rule to obtain an initial BPF of the fan under each pulse width modulation (PWM) duty ratio; and
constructing, based on all PWM duty ratios corresponding to the stepped frequency sweep and the initial BPF under each PWM duty ratio, a mapping table of the PWM duty ratios and the BPFs;
wherein calculating the deviation percentage between the BPF and a reference BPF comprises:
determining a current PWM duty ratio corresponding to the BPF;
determining the reference BPF based on the current PWM duty ratio and the initial BPF in the mapping table; and
calculating the deviation percentage between the BPF and the reference BPF.

4. The fan monitoring method according to claim 3, wherein determining the reference BPF based on the current PWM duty ratio and the initial BPF in the mapping table comprises:
in response to determining that the current PWM duty ratio corresponding to the BPF exists in the mapping table, using the initial BPF corresponding to the current PWM duty ratio in the mapping table as the reference BPF;
in response to determining that the current PWM duty ratio corresponding to the BPF does not exist in the mapping table, determining a first target PWM duty ratio and a second target PWM duty ratio in the mapping table based on the current PWM duty ratio, and calculating a reference BPF corresponding to the current PWM duty ratio according to an initial BPF corresponding to the first target PWM duty ratio and an initial BPF corresponding to the second target PWM duty ratio, wherein the first target PWM duty ratio is adjacent to the second target PWM duty ratio, the first target PWM duty ratio is less than the current PWM duty ratio, and the second target PWM duty ratio is greater than the current PWM duty ratio.

5. The fan monitoring method according to claim 4, wherein calculating the reference BPF corresponding to the current PWM duty ratio according to the initial BPF corresponding to the first target PWM duty ratio and the initial BPF corresponding to the second target PWM duty ratio comprises:
determining a first initial BPF corresponding to the first target PWM duty ratio and a second initial BPF corresponding to the second target PWM duty ratio; and
performing differential calculation on the first initial BPF and the second initial BPF to obtain the reference BPF corresponding to the current PWM duty ratio.

6. The fan monitoring method according to claim 1, wherein the signal feature data comprises one or more of: time-domain feature data, frequency-domain feature data, or time-frequency-domain feature data.

7. The fan monitoring method according to claim 1, wherein obtaining the BPF of the fan based on the noise signal comprises:
performing fast Fourier transform (FFT) processing on the noise signal to obtain spectral data; and
calculating the BPF based on the spectral data.

8. The fan monitoring method according to claim 7, wherein performing the FFT processing on the noise signal to obtain the spectral data comprises:
performing FFT processing on the noise signal to convert the noise signal from a time domain to a frequency domain to obtain the spectral data.

9. The fan monitoring method according to claim 1, wherein the diagnostic data comprises one or more of: health status, or fault status and fault causes corresponding to the fault status.

10. The fan monitoring method according to claim 9, wherein the fault causes comprise one or more of blade eccentricity, bearing wear, winding performance degradation, insufficient or drained lubricating oil, or resistance changes of integrated circuit (IC) elements.

11. The fan monitoring method according to claim 1, further comprising:
adjusting a speed of the fan by the BPF.

12. The fan monitoring method according to claim 11, wherein the BPF is proportional to the speed of the fan.

13. The fan monitoring method according to claim 1, further comprising pre-constructing the status diagnostic model, comprises by:
acquiring noise samples of the fan in a target electronic device, wherein the noise samples comprise fault noise samples and non-fault noise samples, and adding respective labels to the fault noise samples and the non-fault noise samples;
extracting feature data in each of the noise samples, combining the feature data into matrix samples, and dividing the matrix samples into first matrix samples and second matrix samples;
inputting the first matrix samples into a classifier for training to obtain a plurality of models; and
loading the second matrix samples into the plurality of models for testing, and selecting an optimal model as the status diagnostic model according to test results.

14. The fan monitoring method according to claim 13, wherein the adding the respective labels to the fault noise samples and the non-fault noise samples comprises:
setting the labels of the non-fault noise samples as non-fault; and
setting the labels of the fault noise samples as the fault causes.

15. The fan monitoring method according to claim 1, further comprising:
verifying sensitivity of the microphone after server products are assembled and before leaving the factory
wherein acquiring, by the microphone, the noise signal of the fan comprises acquiring the noise signal of the fan after the sensitivity verification of the microphone is passed.

16. The fan monitoring method according to claim 1, wherein the microphone is disposed on a side of a mainboard of a server near the fan.

17. (canceled)

18. A fan monitoring apparatus, comprising:
a memory having computer programs stored thereon; and
a processor configured to execute the computer programs, wherein upon execution of the computer programs, the processor is configured to:
acquire, by a microphone, a noise signal of a fan;
obtain signal feature data and a blade passing frequency (BPF) of the fan based on the noise signal;
input the signal feature data into a pre-constructed status diagnostic model to obtain diagnostic data; and
generate status diagnostic prompt information for the fan based on the diagnostic data and the BPF.

19. (canceled)

20. A non-volatile computer-readable storage medium, wherein the non-volatile computer-readable storage medium stores thereon computer programs that, when executed by a processor, cause the processor to:
acquire, by a microphone, a noise signal of a fan;
obtain signal feature data and a blade passing frequency (BPF) of the fan based on the noise signal;
input the signal feature data into a pre-constructed status diagnostic model to obtain diagnostic data; and
generate status diagnostic prompt information for the fan based on the diagnostic data and the BPF.

21. The fan monitoring apparatus according to claim 18, wherein the processor, upon execution of the computer programs, is further configured to:
calculate a deviation percentage between the BPF and a reference BPF,
wherein in order to generate the status diagnostic prompt information for the fan based on the diagnostic data and the BPF, the processor, upon execution of the computer programs, is configured to:
generate the status diagnostic prompt information for the fan based on the diagnostic data and the deviation percentage.

22. The fan monitoring apparatus according to claim 21, wherein the processor, upon execution of the computer programs, is further configured to:
perform stepped frequency sweep on the fan according to a preset rule to obtain an initial BPF of the fan under each pulse width modulation (PWM) duty ratio; and
construct, based on all PWM duty ratios corresponding to the stepped frequency sweep and the initial BPF under each PWM duty ratio, a mapping table of the PWM duty ratios and the BPFs;
wherein in order to calculate the deviation percentage between the BPF and the reference BPF, the processor, upon execution of the computer programs, is configured to:
determine a current PWM duty ratio corresponding to the BPF;
determine the reference BPF based on the current PWM duty ratio and the initial BPF in the mapping table; and
calculate the deviation percentage between the BPF and the reference BPF.
